(19) United States
(12) Patent Application Publication
(10) Pub. No.: US 2015/0152314 A1
(43) Pub. Date: Jun. 4, 2015

(54) Cement Composition Comprising Nano-Platelets

(71) Applicant: HALLIBURTON ENERGY SERVICES, INC., Houston, TX (US)

(72) Inventors: Ramesh Muthusamy, Pune (ID); Abhimanyu Pramod Deshpande, Pune (ID); Dibyadarshani Senapati, Pune (ID); Rahul Chandrakant Patil, Pune (ID)

(73) Assignee: HALLIBURTON ENERGY SERVICES, INC., Houston, TX (US)

(21) Appl. No.: 14/094,029

(22) Filed: Dec. 2, 2013

(51) Int. Cl. C09K 8/42; E21B 33/13

(52) U.S. Cl. CPC C09K 8/42; E21B 33/13

(57) ABSTRACT

A method of cementing a subterranean formation includes providing a cement composition comprising cementitious material, aqueous base fluid, graphene nano-platelets, and a dispersant; introducing the cement composition into a subterranean formation; and allowing the cement composition to set in the subterranean formation. Upon setting, the cement has at least one of enhanced compressive and tensile strength; reduced permeability; restricted penetration of carbon dioxide; and combinations thereof relative to an equivalent cement without graphene nano-platelets. Cement compositions include cementitious material, an aqueous base fluid, graphene nano-platelets, and a dispersant.

### BACKGROUND

Cementing is a common well operation. For example, hydraulic cement compositions can be used in cementing operations in which a string of pipe, such as casing or liner, is cemented in a wellbore. The cemented string of pipe isolates different zones of the wellbore from each other and from the surface. Hydraulic cement compositions can be used in primary cementing of the casing or in completion operations. Hydraulic cement compositions can also be utilized in intervention operations, such as in plugging highly permeable zones or fractures in zones that may be producing too much water, plugging cracks or holes in pipe strings, and the like.

Cementing and Hydraulic Cement Compositions

In performing cementing, a hydraulic cement composition is pumped as a fluid (typically in the form of suspension or slurry) into a desired location in the wellbore. For example, in cementing a casing or liner, the hydraulic cement composition is pumped into the annular space between the exterior surfaces of a pipe string and the borehole (that is, the wall of the wellbore). The cement composition is allowed time to set in the annular space, thereby forming an annular sheath of hardened, substantially impermeable cement. The hardened cement supports and positions the pipe string in the wellbore and bonds the exterior surfaces of the pipe string to the walls of the wellbore.

Hydraulic cement is a material that when mixed with water hardens or sets over time because of a chemical reaction with the water. Because this is a chemical reaction with the water, hydraulic cement is capable of setting even under water. The hydraulic cement, water, and any other components are mixed to form a hydraulic cement composition in the initial state of a slurry, which should be a fluid for a sufficient time before setting for pumping the composition into the wellbore and for placement in a desired downhole location in the well.

High aspect ratio materials such as glass fibers or polypropylene fibers are known to enhance the tensile strength of set cement. Glass fibers and polypropylene fibers have limitations of poor shear stability and degradation at high temperature respectively. They also require special mixing procedures in the lab and field. Therefore, it is necessary to identify a material that can be mixed easily and at the same time enhances the mechanical and chemical properties of set cement.

### BRIEF DESCRIPTION OF THE DRAWINGS

The following figures are included to illustrate certain aspects of the present invention, and should not be viewed as exclusive embodiments. The subject matter disclosed is capable of considerable modification, alteration, and equivalents in form and function, as will occur to one having ordinary skill in the art and having the benefit of this disclosure.

FIG. 1 shows an illustrative example of an apparatus useful for cementing a wellbore with the cement compositions of the invention.

FIGS. 2-8 show the compressive strength measurements of various cement compositions according to the invention.

FIGS. 9A and 9B show the carbonization of cements according to the invention after exposure to CO₂.

### DETAILED DESCRIPTION

The present invention generally relates to the use of cement compositions in subterranean operations, and, more specifically, to cement compositions with graphene nano-particles and methods of using these compositions in various subterranean operations.

A novel use of graphene nano-platelets is to utilize them in cement compositions for down hole applications. In an exemplary embodiment, a method of cementing a subterranean formation comprises providing a cement composition comprising cementitious materials, aqueous base fluids, graphene nano-platelets, and a dispersant; introducing the cement composition into a subterranean formation; and allowing the cement composition to set in the subterranean formation, wherein upon setting, said cement has at least one of enhanced compressive and tensile strength; reduced permeability; restricted penetration of carbon dioxide; and combinations thereof relative to an equivalent cement without graphene nano-platelets. In an exemplary embodiment, the cement has enhanced compressive and tensile strength. In another embodiment, the cement has reduced permeability. In yet another embodiment, the cement has restricted penetration of carbon dioxide. In some embodiments, the dispersant comprises at least one dispersant selected from the group consisting of a sulfonated-formaldehyde-based dispersant, polystyrene sulfonate dispersant, a polycarboxylated ether dispersant, and any combination thereof. In further embodiments the dispersant is present in the amount of about 0.01 to about 0.2 gal/sack. In some embodiments, the dispersant is not a nanoscale material with at least one physical property of 1 to 100 nanometers. In certain embodiments, the graphene nano-platelets are present in an amount of about 0.05% to about 3.0% by weight of cement. In several embodiments, the graphene nano-platelets are aggregates of sub-micron platelets with diameter of about 2 to about 25 microns. In other embodiments, the thickness of the aggregates of sub-micron platelets is about 2 to about 10 nanometers. In many embodiments, the aqueous base fluid comprises at least one of fresh water; brackish water; saltwater; and combinations thereof and is present in an amount of from about 20% to about 80% by weight of cement. In certain embodiments, the cementitious material comprises at least one of Portland cements; gypsum cements; high alumina content cements; slag cements; high magnesia content cements; shale cements; acid/base cements; fly ash cements; zeolite cement systems; kiln dust cement systems; microfine cements; metakaolin; pumice; and combinations thereof. In certain embodiments, the cement compositions further comprise at least one of resins; latex; stabilizers; silica; pozzolans; microspheres; aqueous superabsorbers; viscosifying agents; suspending agents; dispersing agents; salts; accelerants; surfactants; retardants; defoamers; settling-prevention agents; weighting materials; fluid loss control agents; elastomers; vitrified shale; gas migration control additives; formation conditioning agents; and combinations thereof. In another embodiment, the density of the cement before curing is from about 7 pounds per gallon to about 20 pounds per gallon.

The invention is also directed to cement compositions. In an exemplary embodiment, a well cement composition comprises: cementitious material; an aqueous base fluid; graphene nano-platelets; and a dispersant, wherein upon curing, said cement has at least one of enhanced compressive and tensile strength; reduced permeability; restricted penetration of carbon dioxide; and combinations thereof relative to an equivalent cement without graphene nano-platelets. In an exemplary embodiment, the cement has enhanced compressive and tensile strength. In another embodiment, the cement has reduced permeability. In yet another embodiment, the cement has restricted penetration of carbon dioxide. In some embodiments, the dispersant comprises at least one dispersant selected from the group consisting of a sulfonated-formaldehyde-based dispersant, a polycarboxylated ether dispersant, and any combination thereof. In further embodiments the dispersant is present in the amount of about 0.01 to about 0.2 gal/sack. In some embodiments, the dispersant is not a nanoscale material with at least one physical property of 1 to 100 nanometers. In certain embodiments, the graphene nano-platelets are present in an amount of about 0.05% to about 3.0% by weight of cement. In several embodiments, the graphene nano-platelets are aggregates of sub-micron platelets with diameter of about 2 to about 25 microns. In other embodiments, the thickness of the aggregates of sub-micron platelets is about 2 to about 10 nanometers. In many embodiments, the aqueous base fluid comprises at least one of fresh water; brackish water; saltwater; and combinations thereof and is present in an amount of from about 20% to about 80% by weight of cement. In certain embodiments, the cementitious material comprises at least one of Portland cements; gypsum cements; high alumina content cements; slag cements; high magnesia content cements; shale cements; acid/base cements; fly ash cements; zeolite cement systems; kiln dust cement systems; microfine cements; metakaolin; pumice; and combinations thereof. In certain embodiments, the cement compositions further comprise at least one of resins; latex; stabilizers; silica; pozzolans; microspheres; aqueous superabsorbers; viscosifying agents; suspending agents; dispersing agents; salts; accelerants; surfactants; retardants; defoamers; settling-prevention agents; weighting materials; fluid loss control agents; elastomers; vitrified shale; gas migration control additives; formation conditioning agents; and combinations thereof. In another embodiment, the density of the cement before curing is from about 7 pounds per gallon to about 20 pounds per gallon.

The invention is also directed to a wellbore cementing system. In an embodiment, a cementing system comprises an apparatus configured to: provide a cement composition comprising cementitious material, aqueous base fluid, graphene nano-platelets, and a dispersant; introduce the cement composition into a subterranean formation; and allow the cement composition to set in the subterranean formation, wherein upon setting, said cement has at least one of enhanced compressive and tensile strength; reduced permeability; restricted penetration of carbon dioxide; and combinations thereof relative to an equivalent cement without graphene nano-platelets. In an exemplary embodiment, the cement has enhanced compressive and tensile strength. In another embodiment, the cement has reduced permeability. In yet another embodiment, the cement has restricted penetration of carbon dioxide. In some embodiments, the dispersant comprises at least one dispersant selected from the group consisting of a sulfonated-formaldehyde-based dispersant, a polycarboxylated ether dispersant, and any combination thereof. In further embodiments the dispersant is present in the amount of about 0.01 to about 0.2 gal/sack. In some embodiments, the dispersant is not a nanoscale material with at least one physical property of 1 to 100 nanometers. In certain embodiments, the graphene nano-platelets are present in an amount of about 0.05% to about 3.0% by weight of cement. In several embodiments, the graphene nano-platelets are aggregates of sub-micron platelets with diameter of about 2 to about 25 microns. In other embodiments, the thickness of the aggregates of sub-micron platelets is about 2 to about 10 nanometers. In many embodiments, the aqueous base fluid comprises at least one of fresh water; brackish water; saltwater; and combinations thereof and is present in an amount of from about 20% to about 80% by weight of cement. In certain embodiments, the cementitious material comprises at least one of Portland cements; gypsum cements; high alumina content cements; slag cements; high magnesia content cements; shale cements; acid/base cements; fly ash cements; zeolite cement systems; kiln dust cement systems; microfine cements; metakaolin; pumice; and combinations thereof. In certain embodiments, the cement compositions further comprise at least one of resins; latex; stabilizers; silica; pozzolans; microspheres; aqueous superabsorbers; viscosifying agents; suspending agents; dispersing agents; salts; accelerants; surfactants; retardants; defoamers; settling-prevention agents; weighting materials; fluid loss control agents; elastomers; vitrified shale; gas migration control additives; formation conditioning agents; and combinations thereof. In another embodiment, the density of the cement before curing is from about 7 pounds per gallon to about 20 pounds per gallon.

Graphene Nano-Platelets

Nanostructured materials useful in the present invention include graphene nano-platelets. Graphene is an allotrope of carbon, whose structure is a planar sheet of sp²-bonded graphite atoms that are densely packed in a 2-dimensional honeycomb crystal lattice. The term “graphene” is used herein to include particles that may contain more than one atomic plane, but still with a layered morphology, i.e. one in which one of the dimensions is significantly smaller than the other two. According to an embodiment of the present invention, the graphene nano-platelets are aggregates of sub-micron platelets with diameter of about 2 to about 25 microns. In another embodiment, thickness of the aggregates of sub-micron platelets is about 2 to about 10 nanometers. In certain embodiments, the graphene nano-platelets are present in the amount of about 0.05% to about 3% by weight of cement (bwoc), about 0.1% to about 2% bwoc, and about 0.2 to about 1.5% bwoc.

A suitable graphene nano-platelet for use in the present invention is commercially available from Strem Chemicals, Inc., in Newburyport, Mass. The composition has a carbon content of >98 wt %, planar structure, specific gravity of 2.12 g/cc, plate dimensions of 6-8 nm thick and 2 μm wide, a surface area of 750 m²/g, tensile strength of 5 GPa.

Aqueous Base Fluids

An aqueous base fluid in the cement compositions of the invention is present in an amount sufficient to make a slurry which is pumpable for introduction down hole. In some embodiments, the aqueous base fluid comprises at least one of fresh water; brackish water; saltwater; and combinations thereof. The water may be fresh water, brackish water, saltwater, or any combination thereof. In certain embodiments, the water may be present in the cement composition in an amount of from about 20% to about 80% by weight of cement (“bwoc”), from about 28% to about 60% bwoc, or from about 36% to about 66% bwoc.

Dispersants

Dispersants are present in the cement compositions of the invention. Examples of suitable dispersants include, without limitation, sulfonated-formaldehyde-based dispersants, sulfonated water soluble polymers and polycarboxylated ether dispersants. One example of a suitable sulfonated-formaldehyde-based dispersant that may be suitable is a sulfonated acetone formaldehyde condensate, available from Halliburton Energy Services, Inc., as CFR-3™ dispersant. One example of a suitable polycarboxylated ether dispersant that may be suitable is Liquiment® 514L dispersant, available from BASF Corporation, Houston, Tex., that comprises 36% by weight of the polycarboxylated ether in water. Another example of a suitable polycarboxylated ether dispersant that may be suitable is Coatex™ XP 1629 dispersant, available from Coatex LLC. One example of a suitable sulfonated water soluble polymer that may be suitable is a polystyrene sulfonate, available from Halliburton Energy Services, Inc., as Gelmodifier 750L. In some embodiments, the dispersant is not a nanoscale material with at least one physical property of 1 to 100 nanometers. In certain embodiments, the dispersants are present in the amount of about 0.01 to about 0.2 gal/sk.

Cementitious Material

A variety of cements can be used in the present invention, including cements comprised of calcium, aluminum, silicon, oxygen, and/or sulfur which set and harden by reaction with water. Such hydraulic cements include Portland cements, gypsum cements, high alumina content cements, slag cements, high magnesia content cements, shale cements, acid/base cements, fly ash cements, zeolite cement systems, kiln dust cement systems, microfine cements, metakaolin, pumice and their combinations. In some embodiments, the suitable API Portland cements are from Classes A, C, H, and G.

Slurry Density

In certain embodiments, the cement compositions have a slurry density which is pumpable for introduction down hole. In exemplary embodiments, the density of the cement composition in slurry form is from about 7 pounds per gallon (ppg) to about 20 ppg, from about 10 ppg to about 18 ppg, or from about 13 ppg to about 17 ppg.

Cement Additives

The cement compositions of the invention may contain additives. In certain embodiments, the additives comprise at least one of resins, latex, stabilizers, silica, pozzolans, microspheres, aqueous superabsorbers, viscosifying agents, suspending agents, dispersing agents, salts, accelerants, surfactants, retardants, defoamers, settling-prevention agents, weighting materials, fluid loss control agents, elastomers, vitrified shale, gas migration control additives, formation conditioning agents, and combinations thereof.

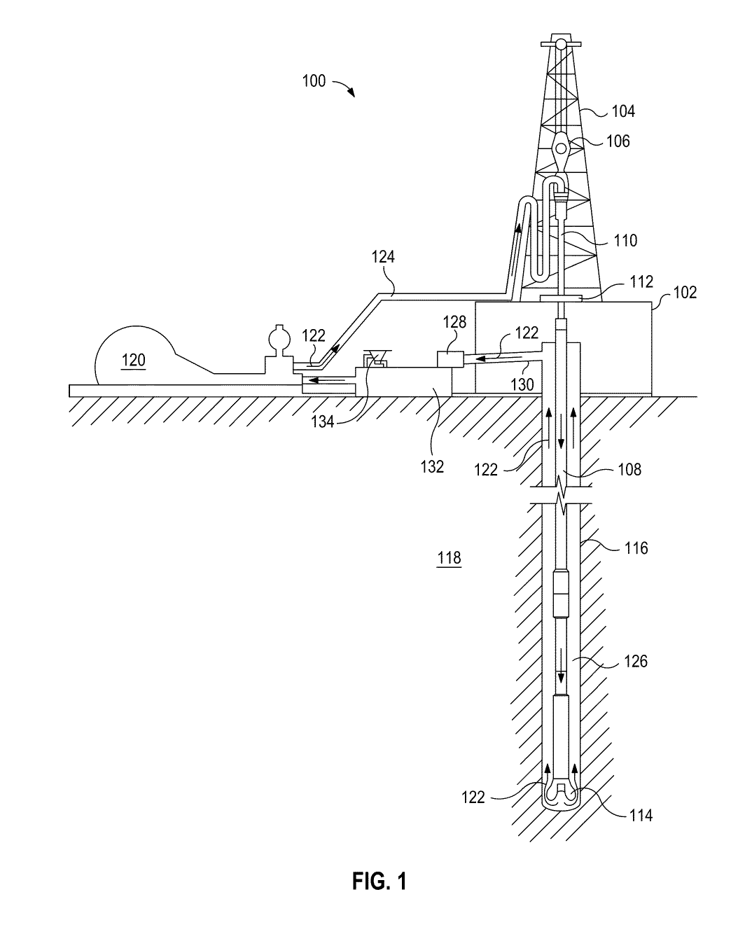

The exemplary cement compositions disclosed herein may directly or indirectly affect one or more components or pieces of equipment associated with the preparation, delivery, recapture, recycling, reuse, and/or disposal of the disclosed cement compositions. For example, and with reference to FIG. 1, the disclosed cement compositions may directly or indirectly affect one or more components or pieces of equipment associated with an exemplary wellbore drilling assembly 100, according to one or more embodiments. It should be noted that while FIG. 1 generally depicts a land-based drilling assembly, those skilled in the art will readily recognize that the principles described herein are equally applicable to subsea drilling operations that employ floating or sea-based platforms and rigs, without departing from the scope of the disclosure.

As illustrated, the drilling assembly 100 may include a drilling platform 102 that supports a derrick 104 having a traveling block 106 for raising and lowering a drill string 108. The drill string 108 may include, but is not limited to, drill pipe and coiled tubing, as generally known to those skilled in the art. A kelly 110 supports the drill string 108 as it is lowered through a rotary table 112. A drill bit 114 is attached to the distal end of the drill string 108 and is driven either by a downhole motor and/or via rotation of the drill string 108 from the well surface. As the bit 114 rotates, it creates a borehole 116 that penetrates various subterranean formations 118.

A pump 120 (e.g., a mud pump) circulates drilling fluid 122 through a feed pipe 124 and to the kelly 110, which conveys the drilling fluid 122 downhole through the interior of the drill string 108 and through one or more orifices in the drill bit 114. The drilling fluid 122 is then circulated back to the surface via an annulus 126 defined between the drill string 108 and the walls of the borehole 116. At the surface, the recirculated or spent drilling fluid 122 exits the annulus 126 and may be conveyed to one or more fluid processing unit(s) 128 via an interconnecting flow line 130. After passing through the fluid processing unit(s) 128, a “cleaned” drilling fluid 122 is deposited into a nearby retention pit 132 (i.e., a mud pit). While illustrated as being arranged at the outlet of the wellbore 116 via the annulus 126, those skilled in the art will readily appreciate that the fluid processing unit(s) 128 may be arranged at any other location in the drilling assembly 100 to facilitate its proper function, without departing from the scope of the scope of the disclosure.

One or more of the disclosed cement compositions may be added to the drilling fluid 122 via a mixing hopper 134 communicably coupled to or otherwise in fluid communication with the retention pit 132. The mixing hopper 134 may include, but is not limited to, mixers and related mixing equipment known to those skilled in the art. In other embodiments, however, the disclosed cement compositions may be added to the drilling fluid 122 at any other location in the drilling assembly 100. In at least one embodiment, for example, there could be more than one retention pit 132, such as multiple retention pits 132 in series. Moreover, the retention put 132 may be representative of one or more fluid storage facilities and/or units where the disclosed cement compositions may be stored, reconditioned, and/or regulated until added to the drilling fluid 122.

As mentioned above, the disclosed cement compositions may directly or indirectly affect the components and equipment of the drilling assembly 100. For example, the disclosed cement compositions may directly or indirectly affect the fluid processing unit(s) 128 which may include, but is not limited to, one or more of a shaker (e.g., shale shaker), a centrifuge, a hydrocyclone, a separator (including magnetic and electrical separators), a desilter, a desander, a separator, a filter (e.g., diatomaceous earth filters), a heat exchanger, any fluid reclamation equipment. The fluid processing unit(s) 128 may further include one or more sensors, gauges, pumps, compressors, and the like used store, monitor, regulate, and/or recondition the exemplary cement compositions.

The disclosed cement compositions may directly or indirectly affect the pump 120, which representatively includes any conduits, pipelines, trucks, tubulars, and/or pipes used to fluidically convey the cement compositions downhole, any pumps, compressors, or motors (e.g., topside or downhole) used to drive the cement compositions into motion, any valves or related joints used to regulate the pressure or flow rate of the cement compositions, and any sensors (i.e., pressure, temperature, flow rate, etc.), gauges, and/or combinations thereof, and the like. The disclosed cement compositions may also directly or indirectly affect the mixing hopper 134 and the retention pit 132 and their assorted variations.

The disclosed cement compositions may also directly or indirectly affect the various downhole equipment and tools that may come into contact with the cement compositions such as, but not limited to, the drill string 108, any floats, drill collars, mud motors, downhole motors and/or pumps associated with the drill string 108, and any MWD/LWD tools and related telemetry equipment, sensors or distributed sensors associated with the drill string 108. The disclosed cement compositions may also directly or indirectly affect any downhole heat exchangers, valves and corresponding actuation devices, tool seals, packers and other wellbore isolation devices or components, and the like associated with the wellbore 116. The disclosed cement compositions may also directly or indirectly affect the drill bit 114, which may include, but is not limited to, roller cone bits, PDC bits, natural diamond bits, any hole openers, reamers, coring bits, etc.

While not specifically illustrated herein, the disclosed cement compositions may also directly or indirectly affect any transport or delivery equipment used to convey the cement compositions to the drilling assembly 100 such as, for example, any transport vessels, conduits, pipelines, trucks, tubulars, and/or pipes used to fluidically move the cement compositions from one location to another, any pumps, compressors, or motors used to drive the cement compositions into motion, any valves or related joints used to regulate the pressure or flow rate of the cement compositions, and any sensors (i.e., pressure and temperature), gauges, and/or combinations thereof, and the like.

The invention having been generally described, the following examples are given as particular embodiments of the invention and to demonstrate the practice and advantages hereof. It is understood that the examples are given by way of illustration and are not intended to limit the specification or the claims to follow in any manner.

### Examples

### Material Information

Name: Graphene

Specific gravity: 2.12 g/cc

Plate dimension: 6-8 nm thick and 2 μm wide

Surface area: 750 m²/g

Tensile strength: 5 GPa

Slurry Preparation

Graphene was suspended in water and sonicated for 20 minutes in the presence of Coatex™ XP 1629 (a dispersant sold by Coatex LLC.,) or GelModifier™ 750 L (a dispersant/rheology modifier, available from Halliburton Energy Services, Inc., A cement slurry was prepared using the suspension of graphene whose composition is summarized in Table 1.

TABLE 1
Composition of Slurry, Density = 15.8 ppg

| Material | Amount (% bwoc) |
|---|---|
| Water | 44.87 |
| Class H Cement | 100 |
| Graphene | 0.2-1.0 |
| FWCA | 0.1 |
| Coatex XP or | 0.03 gal/sk |
| GelModifier 750L | |

FWCA—free water cement additive (hydroxyethylcellulose)

(A) Compressive and Tensile Strength Measurement

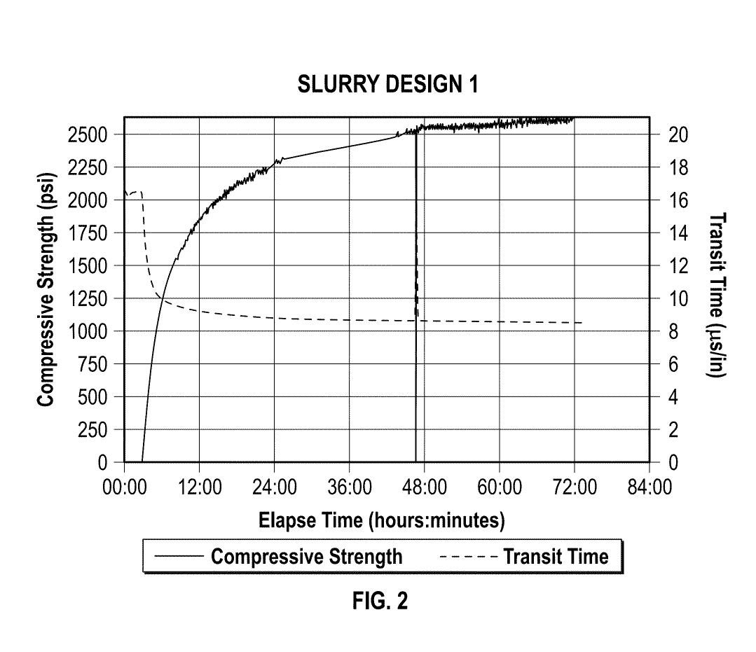

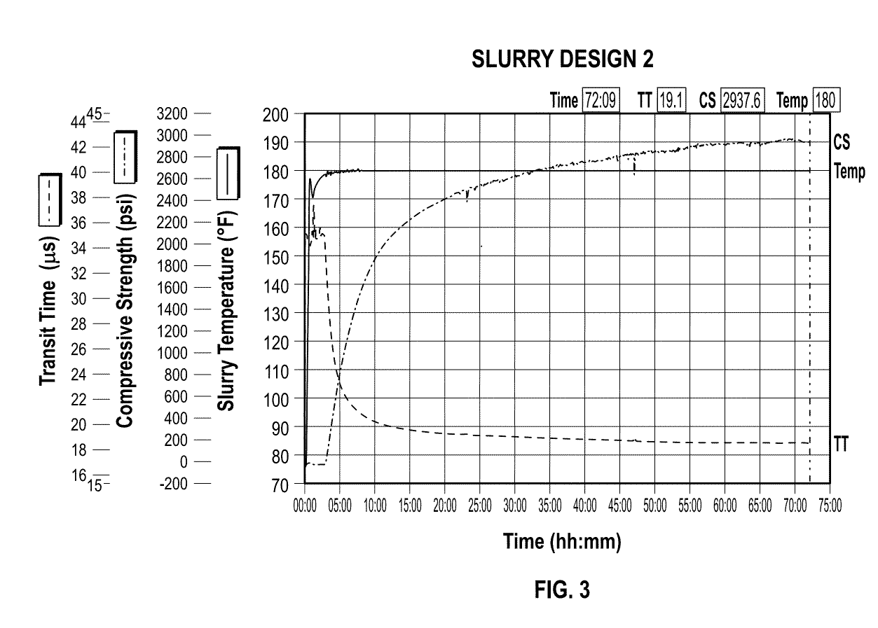

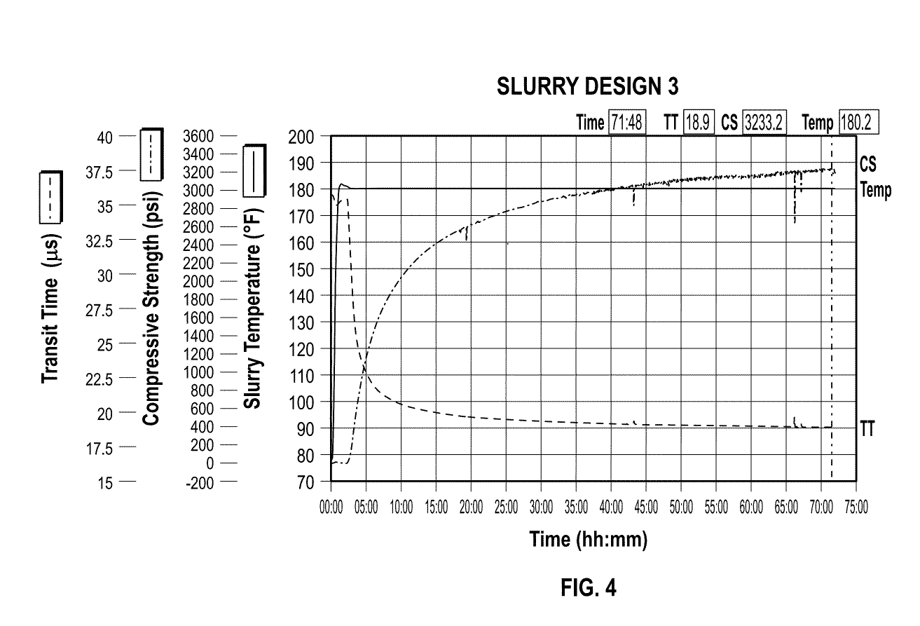

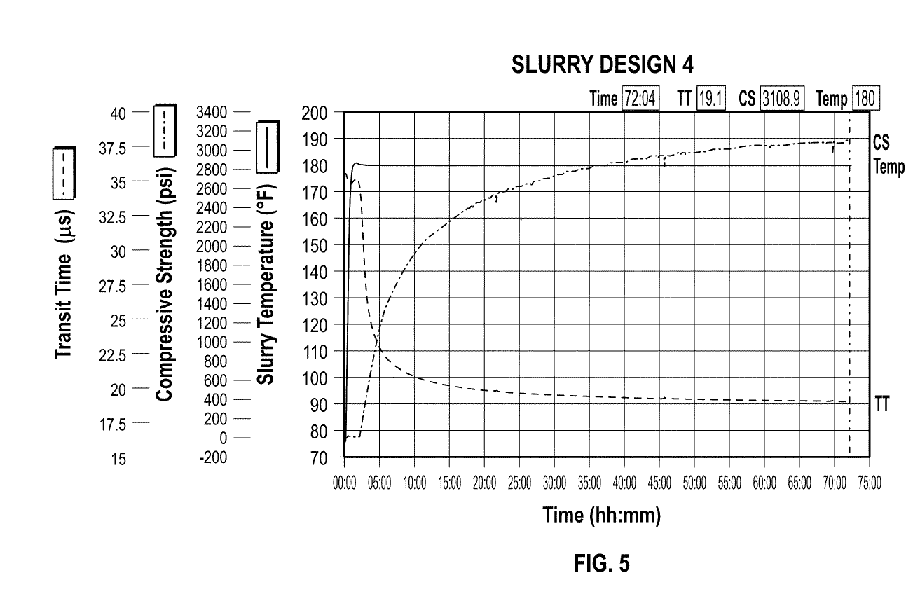

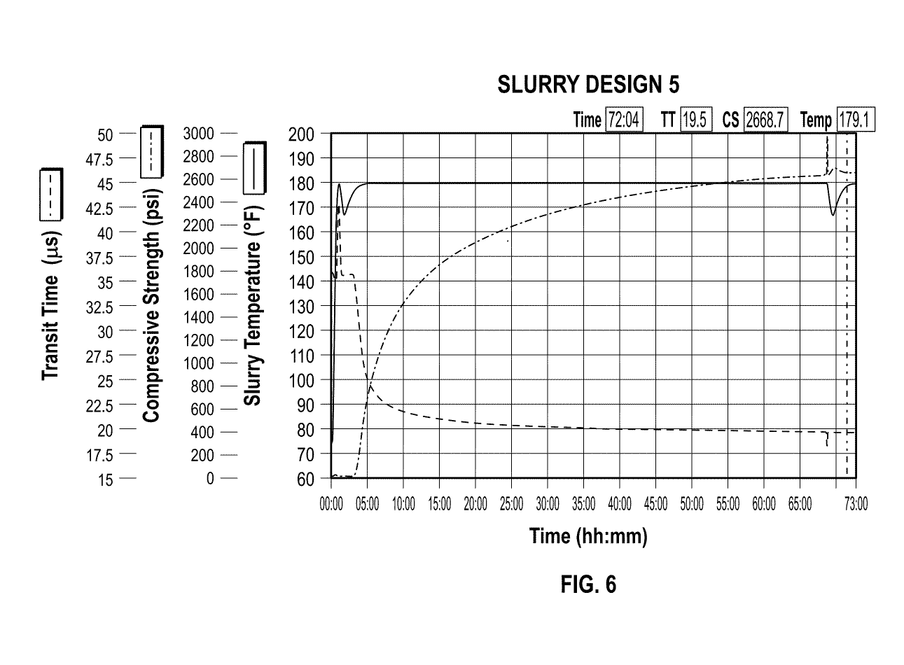

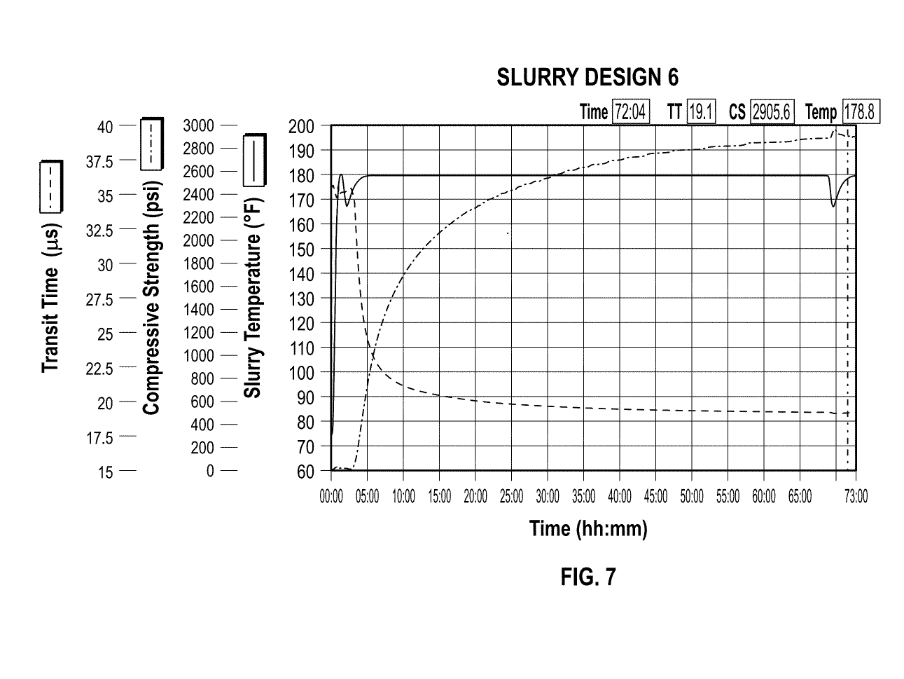

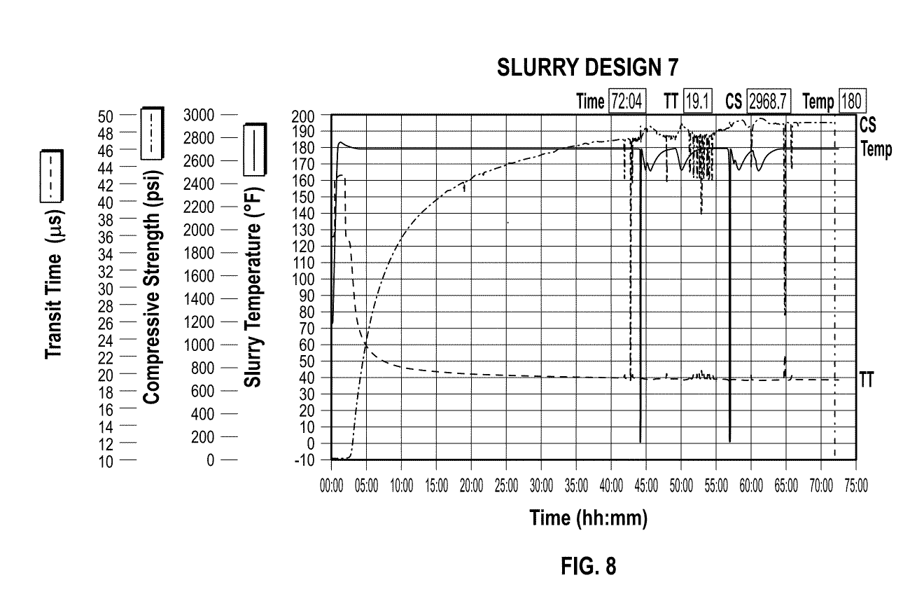

Compressive strength measurement was carried out using an Ultrasonic Cement Analyzer for the period of 72 hours at 180° F. (FIGS. 2-8). Splitting tensile strength was measured using Brazilian method (ASTM C496/C496M). The results are summarized in Table 2.

The ASTM splitting tensile strength is determined with the following equation:

T=(2P)/π|d

Where:

T=Splitting Tensile Strength (psi)

P=Maximum load applied by the load frame (pounds force)

I=Length of specimen (inches)

d=Diameter of specimen (inches)

Percent increase in compressive or tensile strength is calculated as follows:

Percent change in compressive or tensile strength (%)=[Sample−Control]/Control

TABLE 2
Compressive and tensile strength of Control and Graphene loaded Samples

| | | | Compressive | % Increase in | Tensile | % Increase |
|---|---|---|---|---|---|---|
| Slurry | Graphene | | Strength at 72 | Compressive | Strength | in Tensile |
| Design | (%) | Dispersant | hours (psi) | Strength | (psi) | Strength |
| 1 | Control | Coatex | 2658 | — | 333 | — |
| 2 | 0.2 | Coatex | 2938 | 10 | 458 | 38 |
| 3 | 0.7 | Coatex | 3233 | 22 | 574 | 72 |
| 4 | 1.0 | Coatex | 3109 | 17 | 492 | 47 |
| 5 | 0.2 | GelModifier | 2669 | 0.5 | 357 | 7.2 |
| 6 | 0.4 | GelModifier | 2906 | 10 | 433 | 30 |
| 7 | 0.7 | GelModifier | 2969 | 12 | 573 | 72 |

(B) Permeability and Stability Against Carbonization

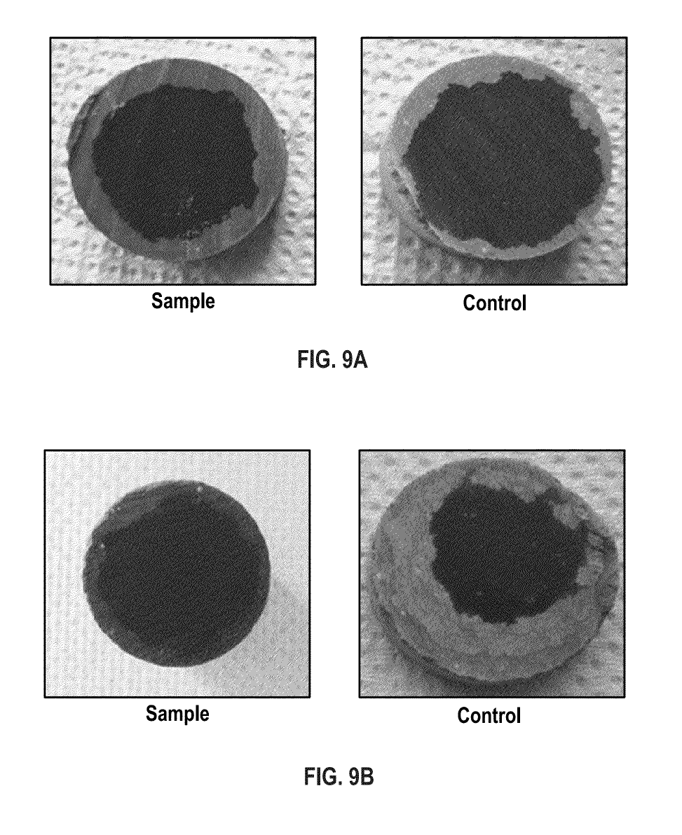

Neat cement slurry and graphene loaded cement slurry (Slurry Design 4) were cured for 7 days at 180° F., and 3000 psi. The samples were exposed to CO₂ at 160° F., and 1000 psi (CO₂). After 28 days, the samples were removed and analyzed for the extent of carbonization using phenolphthalein indicator. Similarly, at the end of 52 days, the carbonization depth was monitored. The images of control and sample are FIGS. 9A,B. The initial carbonization rate was similar for both the control and the sample at the end of 28 days as shown in FIG. 9A. The carbonization depth of the sample observed after 52 days, as seen in FIG. 9B, was almost identical in comparison to the 28 day observation. One of skill in the art may conclude that the rate of carbonization becomes slow or restricted with time. On the other hand, the carbonization depth was continuously increased for the control. Since the graphene has a platelet structure, it increases the diffusional path length through the set cement, which may result in low permeability. This has been confirmed by measuring the permeability for the sample and control at the end of 52 days exposure to CO₂ (Table 3). The results show that the permeability of neat cement (Control) drastically increased upon exposure to CO₂.

TABLE 3
Permeability of Cured Cement Cylinder Before
and After Exposure to CO₂ for 52 Days

Permeability (mD)

| | | After CO₂ |
|---|---|---|
| | Before CO₂ | Exposure |
| Specimen | Exposure | for 52 days |
| Control | 0.00745 | 0.30220 |
| Sample | 0.00670 | 0.00935 |

The permeability of control and sample after exposure to CO₂ for the period of 52 days was 0.3022 mD and 0.00935 mD respectively. These results suggest that the platelet structure of graphene may restrict the penetration of CO₂.

While preferred embodiments of the invention have been shown and described, modifications thereof can be made by one skilled in the art without departing from the spirit and teachings of the invention. The embodiments described herein are exemplary only, and are not intended to be limiting. Many variations and modifications of the invention disclosed herein are possible and are within the scope of the invention. Use of the term “optionally” with respect to any element of a claim is intended to mean that the subject element is required, or alternatively, is not required. Both alternatives are intended to be within the scope of the claim.

Numerous other modifications, equivalents, and alternatives, will become apparent to those skilled in the art once the above disclosure is fully appreciated. It is intended that the following claims be interpreted to embrace all such modifications, equivalents, and alternatives where applicable.

What is claimed is:

1. A method of cementing a subterranean formation comprising:
providing a cement composition comprising cementitious material, aqueous base fluid, graphene nano-platelets, and a dispersant;
introducing the cement composition into a subterranean formation; and
allowing the cement composition to set in the subterranean formation, wherein upon setting, said cement has at least one of enhanced compressive and tensile strength; reduced permeability; restricted penetration of carbon dioxide;
and combinations thereof relative to an equivalent cement without graphene nano-platelets.

2. The method of claim 1, wherein the dispersant comprises at least one dispersant selected from the group consisting of a sulfonated-formaldehyde-based dispersant, polystyrene sulfonate dispersant, a polycarboxylated ether dispersant, and any combination thereof.

3. The method of claim 1, wherein the dispersant is present in the amount of about 0.01 to about 0.2 gal/sack.

4. The method of claim 1, wherein the graphene nano-platelets are present in an amount of about 0.05% to about 3.0% by weight of cement.

5. The method of claim 1, wherein the graphene nano-platelets are aggregates of sub-micron platelets with diameter of about 2 to about 25 microns.

6. The method of claim 5, wherein thickness of the aggregates of sub-micron platelets is about 2 to about 10 nanometers.

7. The method of claim 1, wherein the aqueous base fluid comprises at least one of fresh water; brackish water; saltwater; and combinations thereof.

8. The method of claim 1, wherein the aqueous base fluid is present in the cement composition in an amount of from about 20% to about 80% by weight of cement.

9. The method of claim 1, wherein the cementitious material comprises at least one of Portland cements; gypsum cements; high alumina content cements; slag cements; high magnesia content cements; shale cements; acid/base cements; fly ash cements; zeolite cement systems; kiln dust cement systems; microfine cements; metakaolin; pumice; and combinations thereof.

10. The method of claim 1, further comprising at least one of resins; latex; stabilizers; silica; pozzolans; microspheres; aqueous superabsorbers; viscosifying agents; suspending agents; dispersing agents; salts; accelerants; surfactants; retardants; defoamers; settling-prevention agents; weighting materials; fluid loss control agents; elastomers; vitrified shale; gas migration control additives; formation conditioning agents; and combinations thereof.

11. The method of claim 1, wherein the density of the cement before curing is from about 7 pounds per gallon to about 20 pounds per gallon.

12. The method of claim 1, wherein the dispersant is not a nanoscale material.

13. A well cement composition comprising:
cementitious material;
aqueous base fluid;
graphene nano-platelets; and
a dispersant, wherein upon curing, said cement has at least one of enhanced compressive and tensile strength; reduced permeability; restricted penetration of carbon dioxide; and combinations thereof relative to an equivalent cement without graphene nano-platelets.

14. The cement composition of claim 13, wherein the dispersant comprises at least one dispersant selected from the group consisting of a sulfonated-formaldehyde-based dispersant, polystyrene sulfonate dispersant, a polycarboxylated ether dispersant, and any combination thereof.

15. The cement composition of claim 13, wherein the graphene nano-platelets are present in an amount of about 0.05% to about 3.0% by weight of cement.

16. The cement composition of claim 13, wherein the graphene nano-platelets are aggregates of sub-micron platelets with diameter of about 2 to about 25 microns.

17. The cement composition of claim 13, wherein thickness of the aggregates of sub-micron platelets is about 2 to about 10 nanometers.

18. The cement composition of claim 13, wherein the aqueous base fluid comprises at least one of fresh water; brackish water; saltwater; and combinations thereof.

19. The cement composition of claim 13, wherein the aqueous base fluid is present in the cement composition in an amount of from about 20% to about 80% by weight of cement.

20. The cement composition of claim 13, wherein the cementitious material comprises at least one of Portland cements; gypsum cements; high alumina content cements; slag cements; high magnesia content cements; shale cements; acid/base cements; fly ash cements; zeolite cement systems; kiln dust cement systems; microfine cements; metakaolin; pumice; and combinations thereof.

21. The cement composition of claim 13, further comprising at least one of resins; latex; stabilizers; silica; pozzolans; microspheres; aqueous superabsorbers; viscosifying agents; suspending agents; dispersing agents; salts; accelerants; surfactants; retardants; defoamers; settling-prevention agents; weighting materials; fluid loss control agents; elastomers; vitrified shale; gas migration control additives; formation conditioning agents; and combinations thereof.

22. The cement composition of claim 13, wherein the density of the cement before curing is from about 7 pounds per gallon to about 20 pounds per gallon.

23. The cement composition of claim 13, wherein the dispersant is not a nanoscale material.

24. A wellbore cementing system comprising:
an apparatus configured to:
provide a cement composition comprising cementitious material, aqueous base fluid, graphene nano-platelets, and a dispersant;
introduce the cement composition into a subterranean formation; and
allow the cement composition to set in the subterranean formation, wherein upon setting, said cement has at least one of enhanced compressive and tensile strength; reduced permeability; restricted penetration of carbon dioxide; and combinations thereof relative to an equivalent cement without graphene nano-platelets.
